(19) United States
(12) Patent Application Publication
(10) Pub. No.: US 2005/0205630 A1
(43) Pub. Date: Sep. 22, 2005

(54) Surf and ski transport

(76) Inventors: David Cooper, Laguna Beach, CA (US); Robert Nugent, Newport Beach, CA (US)

Correspondence Address: MYERS DAWES ANDRAS & SHERMAN, LLP, 19900 MACARTHUR BLVD.,, SUITE 1150, IRVINE, CA, 92612, US

(21) Appl. No.: 10/802,283

(22) Filed: Mar. 16, 2004

(51) Int. Cl. B60R 9/00; B60R 11/00

(52) U.S. Cl. 224/521; 224/525

(57) ABSTRACT

A hitch-mountable, vehicle load carrying apparatus and method is herein disclosed. The device includes a base load-carrying platform, and a vertical support structure connected to a horizontal crossbar structure that is adjustable in height. The device further includes several transverse bars that are also adjustable for secure fitting to the equipment that is to be transported. An exemplary embodiment includes wheels connected to the load-carrying platform for convenient stowage of equipment without physical removal from the device.

### BACKGROUND OF THE INVENTION

1. Field of the Invention

The present invention pertains generally to recreational equipment load carrying devices for vehicles. More particularly, the present invention pertains to a hitch-mountable, load carrying apparatus and method. The present invention is particularly, but not exclusively, useful as a surfboard, snowboard, or snow ski transport device mountable to the rear of vehicle.

2. Description of the Prior Art

As is well known, vehicle load carriers, configured to attach to the exterior of a vehicle, provide a convenient way to transport recreational and sporting good equipment such as surfboards, skis, coolers and similar gear. Surfboards in particular, measuring approximately five feet in length up to about twelve feet, are typically transported using a rack mountable to the roof of a vehicle. While this method saves space within the vehicle, it can often be detrimental to the vehicle exterior. For example, on hot days surfboard wax can melt from the board and stick to the roof of the vehicle. The wax must then be scraped or otherwise removed from the vehicle, which can require a considerable amount of time and effort. In addition, wet surfboards can drip saltwater onto the exterior of the vehicle. Over time, saltwater can corrode the paint on the vehicle's roof, which in turn, could lead to the development of rust.

Transporting a plurality of surfboards presents additional concerns when employing vehicle roof racks. For instance, loading boards on a vehicle's roof requires stacking the boards directly on top of one another. Unless the boards themselves have a protective covering, the stacking of boards will cause the transfer of surfboard wax from one board to another. Any wax accumulating on the bottom side of a surfboard will need to be removed prior to use. Additionally, stacking a large number of boards is difficult to accomplish in a secure fashion. Further, the unloading and storing of surfboards can be a laborious task.

It may also be more easy and convenient to transport many different kinds of recreational equipment using a device other than on the roof of a vehicle. Prior art examples of devices that mount to the rear of a vehicle exist for transporting bicycles and other recreational gear. However, a need exists for a rear hitch-mountable device capable of transporting objects that are generally long and slender in shape.

In light of the above, it is an object of the present invention to provide a device and method for carrying recreational equipment that is hitch-mountable to the rear of a vehicle. Another object of the present invention is to provide a vehicle load-carrying device that is capable of securing surfboards, and other similarly shaped objects in an upright position. Still another object of the present invention is to provide a device and method for convenient transporting and stowing surfboards and other recreational equipment. Yet another object of the present invention is to provide a hitch-mountable, vehicle equipment carrying device that is adjustable to accommodate differently shaped objects of varying sizes. It is yet still another object of the present invention to provide a device and method for transporting recreational equipment that is easy to manufacture, relatively simple to use, and comparatively cost effective.

### BRIEF SUMMARY OF THE INVENTION

The present invention specifically addresses and alleviates the above-mentioned deficiencies associated with the prior art. More particularly, the present invention, in a first preferred embodiment is a load carrier for mounting to a rear of a vehicle comprising: a load carrying platform section; a hitch support member defining a transverse axis for mounting to the rear of the vehicle, the hitch support member supporting the load carrying platform; a vertical support member defining a vertical axis and connected to the hitch support member; a horizontal cross-bar member defining a horizontal axis and connected to the vertical support member; and a plurality of transverse bars connected to the horizontal cross-bar member in the transverse axis direction, the load carrying platform for supporting a load, and the plurality of transverse bars for securing the load.

The first preferred embodiment has sub features, particularly the plurality of transverse bars comprise a fixed transverse bar attached to the horizontal bar at an end thereof; and an adjustable transverse bar slidingly disposed on the horizontal cross-bar for securing the load. Further, the adjustable transverse bar comprises a clamp assembly on an end thereof, the clamp assembly for slidingly securing the adjustable transverse bar to the horizontal cross bar.

Alternatively, the load-carrying platform has raised sides for aiding in securing the load to the load-carrying platform. Also, the hitch support member comprises a vertical extension for receiving the vertical support member. Preferably, the horizontal crossbar is a first horizontal crossbar, and a second horizontal crossbar is employed and connected to the vertical support member and disposed above the first horizontal crossbar. The second horizontal crossbar will contain a second set of transverse bars to further secure the load.

Importantly, the height of the load-carrying device may be adjusted. For this purpose, the second horizontal cross-bar has a vertical section for connecting to the vertical support member, the vertical section having vertically spaced mating holes for adjusting a height of the second horizontal cross bar and adjustably securing to the vertical support member.

Alternatively, the load carrier further comprises wheels connected the load carrying platform section for transporting and stowing the load carrier when the load carrier is not connected to a vehicle. In a preferred embodiment, the load carrying platform section comprises a steel grating material. Further, the plurality of transverse support bars are connected by a horizontal connecting member in a preferred embodiment, the horizontal connecting member opposing the horizontal crossbar member. Rubber padding material may also be included to protect surfaces of the load.

The invention may also be characterized as a method for securing a load to a rear of a vehicle comprising the steps of: providing a load carrying platform; supporting the load carrying platform using a hitch support member defining a transverse axis; attaching a vertical support member to the hitch support member; and securing the load using a plurality of transverse bars, the plurality of transverse bars extending in the transverse axis direction from the vertical support member.

The method further comprises the step of securing the plurality of transverse bars to the vertical support member using a horizontal cross bar member. Yet another step comprises slidingly adjusting at least one of the transverse bars to the horizontal cross bar member on an end thereof. Yet still further, the method comprises adjusting the height of the horizontal cross bar member to accommodate varying sizes of the load.

In another aspect, the invention is characterized as a load carrier for mounting to a rear of a vehicle comprising: a load carrying platform section; a hitch support member supporting the load carrying platform section defining a transverse axis; a vertical support member connected to the hitch support member; a means for adjusting a height of the vertical support member; and a means for securing the load to the vertical support member. Further, the invention comprises a means for securing a load in an upright position.

The means for securing the load to the vertical support member further comprises a horizontal cross-bar member defining a horizontal axis and connected to the vertical support member; and a plurality of transverse bars connected to the horizontal crossbar member in the transverse axis direction, the load carrying platform for supporting a load, and the plurality of transverse bars for securing the load. Further, the adjustable transverse bar comprises a clamp assembly on an end thereof, the clamp assembly for slidingly securing the adjustable transverse bar to the horizontal cross bar.

The load carrier of the invention may alternatively comprise two horizontal crossbars, the second horizontal crossbar connected to the vertical support member and disposed above the first horizontal crossbar. Further, the plurality of transverse support bars are connected by a horizontal connecting member, the horizontal connecting member opposing the horizontal crossbar member. The load carrying platform section alternatively has a steel grating material and raised sides.

These, as well as other advantages of the present invention, will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an isometric view of a preferred embodiment illustrating a hitch-mountable load carrier of the present invention;

FIG. 2 is a side view of the preferred embodiment of the present invention illustrating structural components;

FIG. 3 is an isometric view of a load carrying platform of the present invention;

FIG. 4 is an isometric view of a vertical support member and a horizontal cross-bar member of the embodiment illustrated in FIG. 1;

FIG. 5a is an is an isometric view of a fixed transverse bar of the present invention;

FIG. 5b is a an isometric view of an end clamp of the present invention;

FIG. 6a is an isometric view of an adjustable transverse bar of the present invention;

FIG. 6b is an isometric view of a threaded extra portion of a clamp of the present invention;

FIG. 6c is an isometric view of an extra portion of a clamp not having threads; and

FIG. 7 is an isometric view of a second horizontal crossbar having a vertical section.

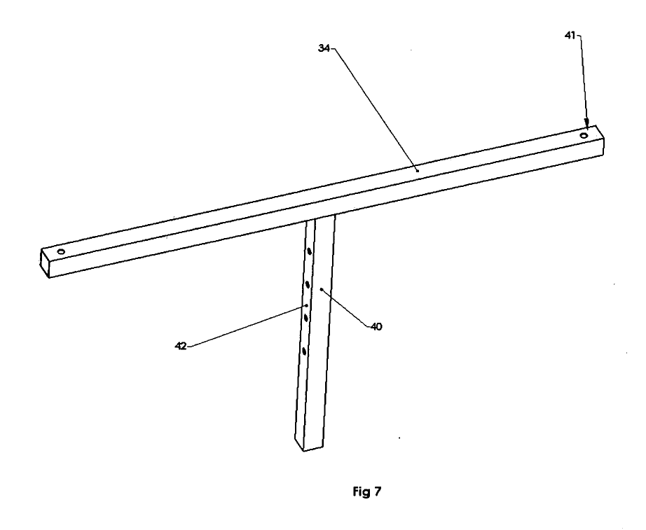

### DETAILED DESCRIPTION OF THE PREFERRED EMBODIMENTS

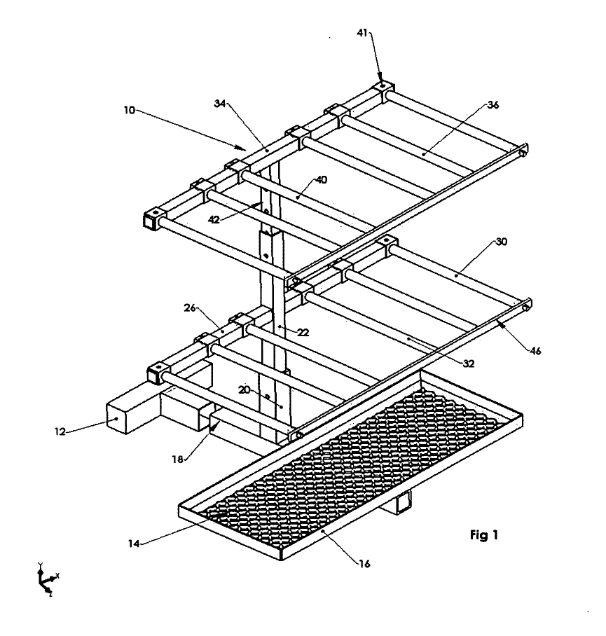

Referring initially to FIG. 1, a load carrier 10 for mounting to a rear of a vehicle is shown and generally designated 10. As shown, the load carrier 10 is mountable to a hitch 12 that is typical for vehicles having trailer capabilities and for mounting devices to a rear of a vehicle. Initially, it should be noted that the load carrier 10 is particularly useful for transporting surfboards and skis. However, it is contemplated that the load carrier 10 is useful for securing a wide variety of equipment and especially such equipment having a generally long and slender shape.

A hitch support member 18 illustrated in FIG. 1 is configured to mount to a rear of a vehicle. For instance, a pin (not shown) could be used for this purpose rated to support typical loads. Hitch support member 18 is configured to support a load-carrying platform 14. It is further contemplated that load carrying platform may be comprised of steel grating material that is durable and not allow water to collect on the load carrying platform 14. Also, the load-carrying platform 14 has raised sides 16.

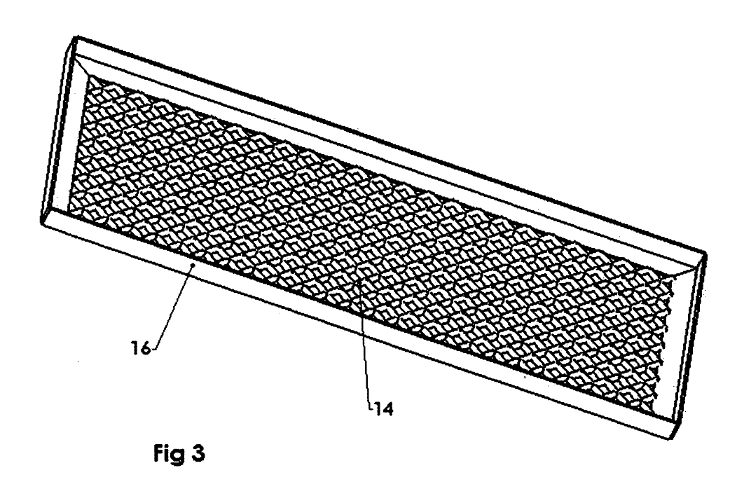

Additionally, hitch support member 18 defines a transverse axis that is the z-axis, as illustrated. Similarly, a vertical support member 22 defines a vertical axis being the y-axis as illustrated. Vertical support member 22 is connected to hitch support member, and in the preferred embodiment illustrated by FIG. 1, the vertical support member is connected via a vertical extension 20 of the hitch support member 22. A pin securing mating holes 23 (FIG. 3) located on vertical extension 20 and the vertical support member 22 may be employed to secure the vertical support member 22. Additionally, the mating holes 23 may be used to adjust the height of the apparatus 10 to accommodate different sized loads.

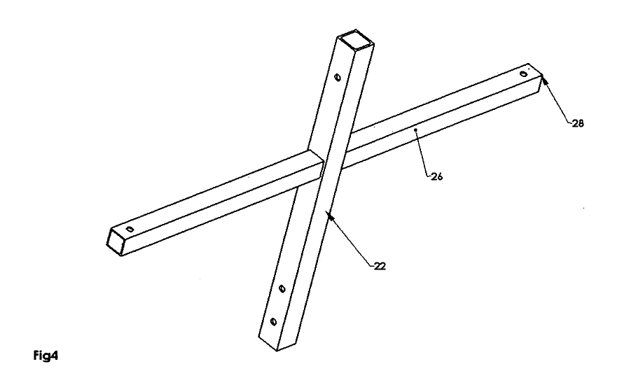

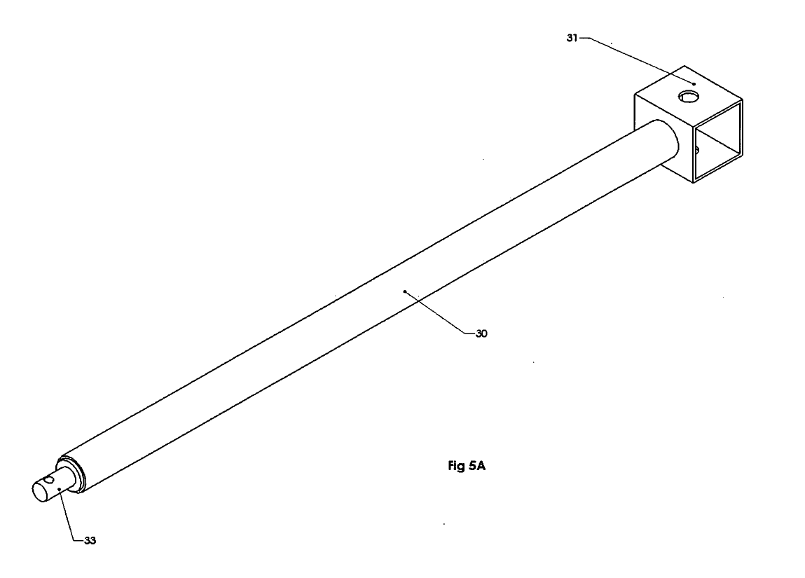

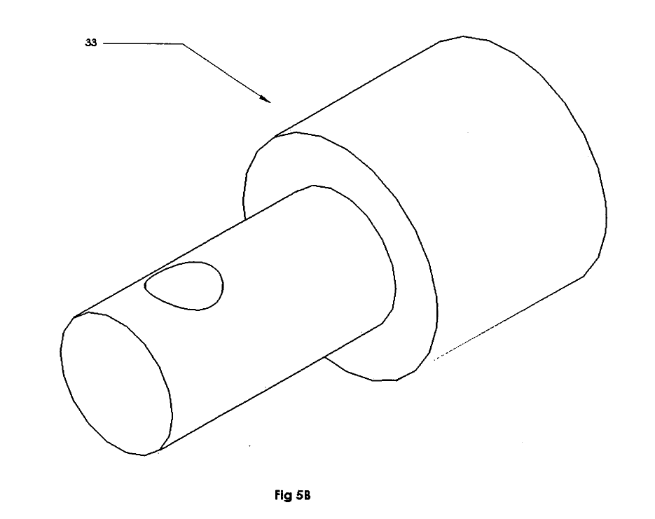

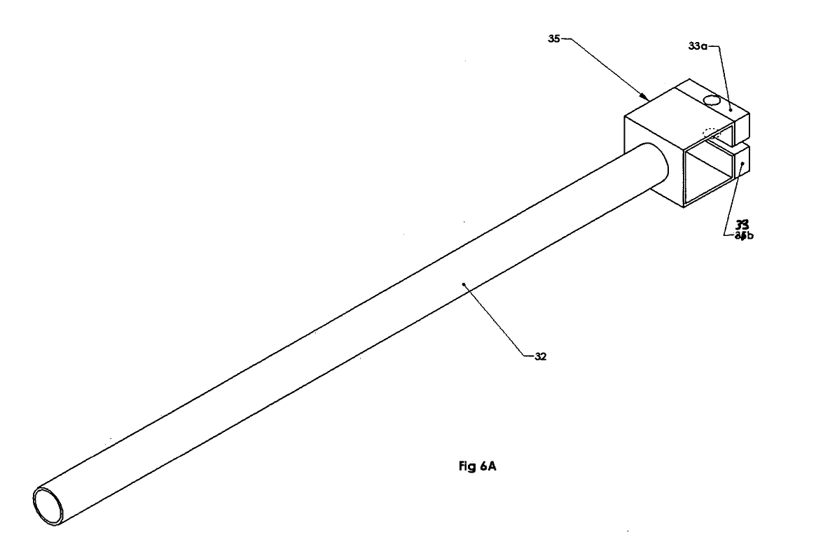

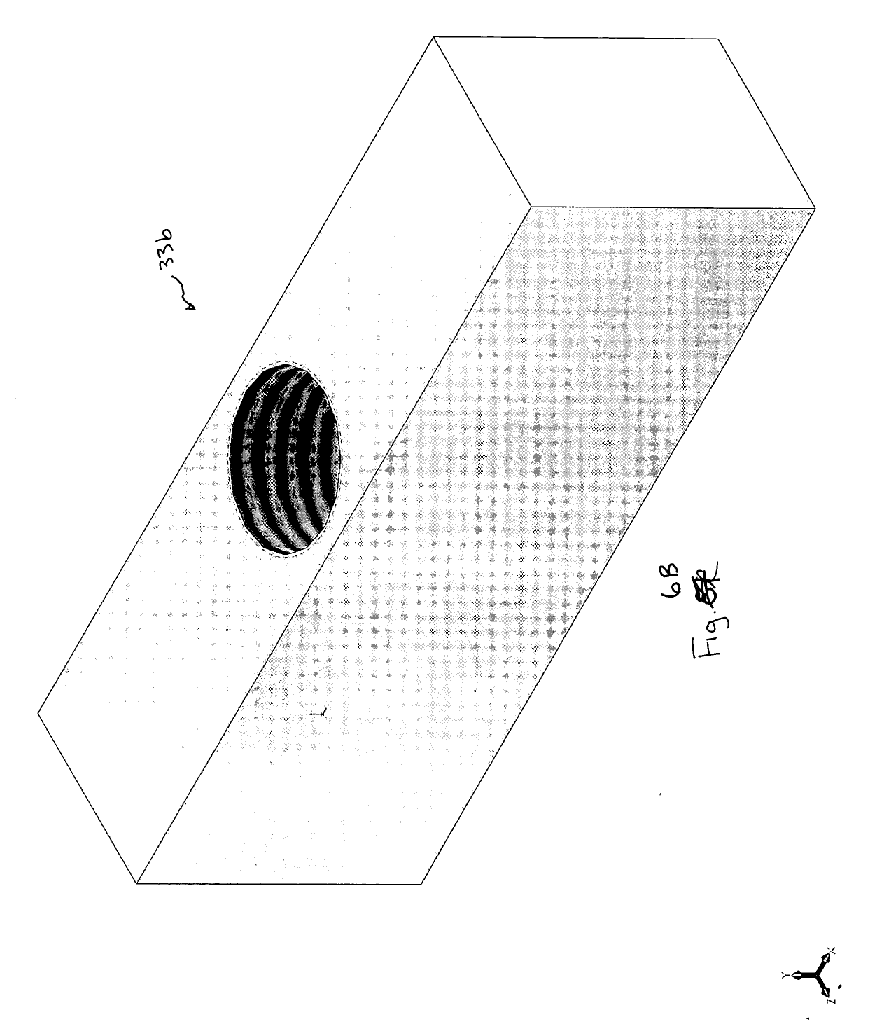

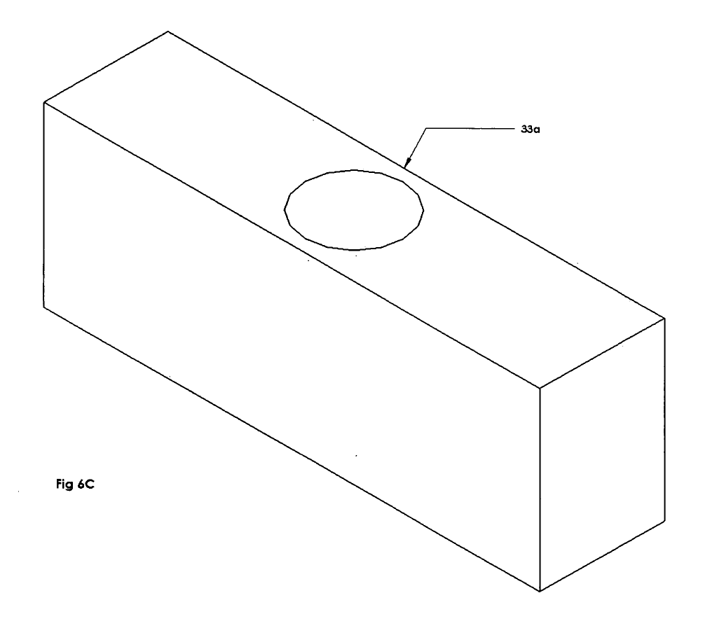

A first horizontal crossbar member 26 is connected to the vertical support member 22 at a vertical distance from the hitch support member 18. This connection is further illustrated in FIG. 4. As is shown in FIG. 1, the first horizontal crossbar member 26 connects a plurality of transverse bars 30, 32. In the preferred embodiment illustrated by FIG. 1, fixed transverse bars 30 are connected to ends of the horizontal crossbar member 26. A fixed transverse bar 30 of the present invention is further illustrated in FIG. 5A. Transverse bars 32 are adjustable in that they are slidingly disposed on the horizontal crossbar member 26. The adjustable transverse bars 32 are used to secure a load. According the invention, a load is secured between two adjustable transverse bars 32 or between a fixed transverse bar 30 and an adjustable transverse bar 32. In a preferred embodiment, clamps 35 are used to release and secure the adjustable transverse bars 32 as illustrated in FIGS. 6A through 6C.

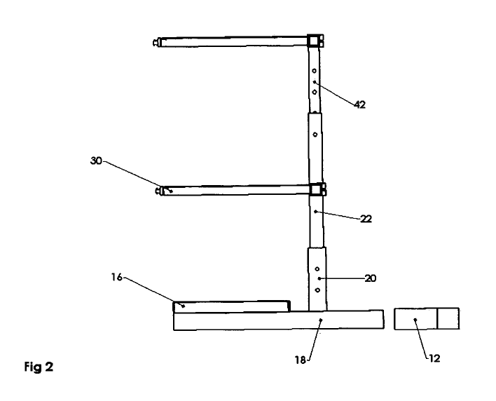

Also shown in the FIG. 1 embodiment, load carrier 10 may optionally include a second horizontal crossbar 34 that is particularly useful in securing relatively large loads. The second horizontal crossbar 34 also has transverse bars 36 that are either fixed or adjustable and configured similarly to the first plurality of transverse bars 30, 32. Importantly, the second horizontal crossbar has a vertical extension 40 for connecting to the vertical support member 22. The vertical extension 40 additionally has mating holes 42 at vertical intervals that can be used to adjust the height of the device 10. A side view of the preferred embodiment is further illustrated in FIG. 2.

Referring to FIG. 3, an isometric view of a load-carrying platform is illustrated. In a preferred embodiment, the platform has raised sides 16. It is contemplated that the load-carrying device 10 could be used without the vertical support member 22 and its connected structure. For example, an ice chest-type cooler could be secured to the load-carrying platform 14. FIG. 4 is another illustration of vertical support member 22 connected to horizontal crossbar member 22. Horizontal crossbar member 26 contains mating holes 28 on an end thereof in order to secure fixed transverse bars 30. Alternatively, the load carrier further has wheels (not shown) connected the load carrying platform section for transporting and stowing the load carrier when the load carrier is not connected to a vehicle. It is further contemplated that the load carrier could be removed from the vehicle and provide convenient upright storage for the equipment secured to the load carrier in a garage, for example. In this way, the load carrier allows a user to avoid unsecuring the equipment an extra time as compared to a roof rack and provides storage means.

As shown in FIG. 5A, fixed transverse bar is secured to horizontal crossbar 26 mating holes 28 using a fixed transverse bar coupling 31. At the opposite end, an extension 33 is used to couple to a horizontal connecting member 46 (FIG. 1). FIG. 5B illustrates a closer view of extension 33. Horizontal connecting member 46 contains a suitable hole to receive the extension 33.

Now referring to FIG. 6A, an adjustable transverse bar 32 is illustrated. Clamp assembly 35, generally has a rectangular part that contains a space on a distal end to allow for tightening of the clamp assembly 35. Extra portions 35a, 35b are welded to the rectangular part to provide for the tightening. In a preferred embodiment, extra portion 35a is not threaded and extra portion 35b is threaded to receive a threaded fastener and allow for the tightening.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

It is understood that the exemplary Surf and Ski Transport described herein and shown in the drawings represents only presently preferred embodiments of the invention. Indeed, various modifications and additions may be made to such embodiments without departing from the spirit and scope of the invention.

Thus, these and other modifications and additions may be obvious to those skilled in the art and may be implemented to adapt the present invention for use in a variety of different applications.

1. A load carrier for mounting to a rear of a vehicle comprising:
a load carrying platform section;
a hitch support member defining a transverse axis for mounting to the rear of the vehicle, said hitch support member supporting said load-carrying platform;
a vertical support member defining a vertical axis and connected to said hitch support member;
a horizontal cross-bar member defining a horizontal axis and connected to said vertical support member; and
a plurality of transverse bars connected to said horizontal crossbar member in the transverse axis direction, the load-carrying platform for supporting a load, and the plurality of transverse bars for securing the load.

2. The load carrier as recited in claim 1, the plurality of transverse bars comprising:
a fixed transverse bar attached to the horizontal bar at an end thereof; and
an adjustable transverse bar slidingly disposed on the horizontal crossbar for securing the load.

3. The load carrier as recited in claim 2, the adjustable transverse bar comprising a clamp assembly on an end thereof, the clamp assembly for slidingly securing the adjustable transverse bar to the horizontal cross bar.

4. The load carrier as recited in claim 1, wherein said load carrying platform has raised sides for aiding in securing the load to the load-carrying platform.

5. The load carrier as recited in claim 1, wherein the hitch support member comprises a vertical extension for receiving said vertical support member.

6. The load carrier as recited in claim 1, wherein the vertical support member comprises a through-hole support for receiving and supporting the horizontal cross-bar member.

7. The load carrier as recited in claim 1, wherein the horizontal cross-bar is a first horizontal cross-bar, and further comprising a second horizontal cross-bar connected to the vertical support member and disposed above the first horizontal cross-bar.

8. The load carrier as recited in claim 7, wherein the plurality of transverse bars are a first set of transverse bars and further comprising a second set of transverse bars connected to the second horizontal cross-bar.

9. The load carrier as recited in claim 8, wherein the second horizontal crossbar comprises mating holes for adjustably securing the second set of transverse bars.

10. The load carrier as recited in claim 7, wherein the second horizontal cross-bar has a vertical section for connecting to the vertical support member, the vertical section having mating holes for adjusting a height of the second horizontal cross bar and adjustably securing to the vertical support member.

11. The load carrier as recited in claim 1, further comprising a plurality of wheels connected the load carrying platform section for transporting and stowing the load carrier when the load carrier is not connected to a vehicle.

12. The load carrier as recited in claim 1, wherein said plurality of transverse support bars are further connected by a horizontal connecting member, said horizontal connecting member opposing said horizontal cross-bar member.

13. The load carrier as recited in claim 1, the load carrying platform section comprising a steel grating material.

14. The load carrier as recited in claim 1, the plurality of transverse bars comprising rubber-padding material to protect surfaces of the load.

15. A method for securing a load to a rear of a vehicle comprising:
providing a load-carrying platform;
supporting the load-carrying platform using a hitch support member defining a transverse axis;
attaching a vertical support member to the hitch support member; and
securing the load using a plurality of transverse bars, the plurality of transverse bars extending in the transverse axis direction from the vertical support member.

16. The method for securing a load to a rear of a vehicle of claim 15, further comprising securing the plurality of transverse bars to the vertical support member using a horizontal cross bar member.

17. The method for securing a load to a rear of a vehicle of claim 16, further comprising slidingly adjusting at least one of the transverse bars to the horizontal cross bar member on an end thereof.

18. The method for securing a load to a rear of a vehicle of claim 16, further comprising adjusting the height of the horizontal cross bar member to accommodate varying sizes of the load.

19. A load carrier for mounting to a rear of a vehicle comprising:
a load carrying platform section;
a hitch support member supporting the load carrying platform section defining a transverse axis;
a vertical support member connected to the hitch support member;
a means for adjusting a height of the vertical support member; and
a means for securing the load to the vertical support member.

20. The load carrier for mounting to a rear of a vehicle of claim 19, wherein the means for securing the load to the vertical support member comprises a means for securing the load to the vertical support member, the load being in an upright position.

21. The load carrier for mounting to a rear of a vehicle of claim 19, the means for securing the load to the vertical support member comprising:
a horizontal cross-bar member defining a horizontal axis and connected to the vertical support member; and
a plurality of transverse bars connected to said horizontal crossbar member in the transverse axis direction, the load-carrying platform for supporting a load, and the plurality of transverse bars for securing the load.

22. The load carrier as recited in claim 2, the adjustable transverse bar comprising a clamp assembly on an end thereof, the clamp assembly for slidingly securing the adjustable transverse bar to the horizontal cross bar.

24. The load carrier as recited in claim 21, wherein the horizontal cross-bar is a first horizontal cross-bar, and further comprising a second horizontal cross-bar connected to the vertical support member and disposed above the first horizontal cross-bar.

25. The load carrier as recited in claim 21, wherein said plurality of transverse support bars are further connected by a horizontal connecting member, said horizontal connecting member opposing said horizontal cross-bar member.

26. The load carrier as recited in claim 19, the load carrying platform section comprising;
a steel grating material; and
raised sides.
